(19) United States
(12) Patent Application Publication
(10) Pub. No.: US 2003/0211763 A1
(43) Pub. Date: Nov. 13, 2003

(54) Compact flash card having energizing device

(76) Inventor: Roger Wu, Hsin Chuang City (TW)

Correspondence Address: Roger WU, P.O.Box 4-67, Hsin Chuang, Taipei, TW

(21) Appl. No.: 10/143,486

(22) Filed: May 7, 2002

(51) Int. Cl. H01R 13/62

(52) U.S. Cl. 439/152

(57) ABSTRACT

A compact flash card includes a coupler for coupling to the computer facility, a circuit board attached to the card and having a number of electric elements, and one or more batteries attached to the card and coupled to the circuit board for energizing the electric elements, and for preventing the compact flash card from consuming the electric energy of the computer facility, and thus for increasing the working life of the computer facility. The card may be indirectly coupled to the computer facility indirectly via a transforming device.

### BACKGROUND OF THE INVENTION

1. Field of the Invention

The present invention relates to a compact flash card, and more particularly to a compact flash card having an energizing device for energizing the compact flash card, and for preventing the compact flash card from consuming the electric energy of the computer facility to which the compact flash card is plugged thereto.

2. Description of the Prior Art

Typical compact flash cards have been developed and provided for attaching into the computer facilities or the other working stations, such as the personal digital assistant (PDA) devices, the notebooks, the personal computers, the pocket computers, the digital cameras, etc., and for memorizing or storing purposes. However, the typical compact flash cards do not have any energizing devices provided therein, such that the compact flash cards may consume the electric energy of the computer facilities or the other working stations, such as the personal digital assistant (PDA) devices, the notebooks, the personal computers, the pocket computers, the digital cameras, etc., and such that the working time of the computer facilities or the other working stations may be greatly reduced.

The present invention has arisen to mitigate and/or obviate the afore-described disadvantages of the conventional compact flash cards.

### SUMMARY OF THE INVENTION

The primary objective of the present invention is to provide a compact flash card including an energizing device for energizing the compact flash card itself, and for preventing the compact flash card from consuming the energy of the computer facilities or the other working stations.

In accordance with one aspect of the invention, there is provided a compact flash card for coupling to a computer facility, the compact flash card comprising a card body including a coupler provided therein for coupling to the computer facility, a circuit board attached to the card body, and including a plurality of electric elements attached thereto, and at least one battery attached to the card body and coupled to the circuit board for energizing the electric elements, and for preventing the compact flash card from consuming an electric energy of the computer facility. The working life of the computer facility thus will not be decreased or shortened, and may thus be relatively increased.

The card body includes a casing attached thereto and having a chamber formed therein for receiving the battery.

The card body includes at least one conductor disposed therein and electrically coupled between the battery and the circuit board, and for electrically coupling the battery to the electric elements of the circuit board.

The card body includes a cover detachably attached to the casing for enclosing the chamber of the casing and for retaining the battery in the chamber of the casing.

A transforming device may further be provided and includes a socket opening formed therein for receiving the coupler of the card body, and for coupling to the computer facility.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a perspective view of a compact flash card in accordance with the present invention;

FIG. 2 is a partial exploded view of the compact flash card;

FIG. 3 is a partial exploded view illustrating the attachment of the compact flash card to the personal digital assistant device; and

FIG. 4 is a partial exploded view similar to FIG. 3; illustrating the attachment of the compact flash card to the notebook.

### DETAILED DESCRIPTION OF THE PREFERRED EMBODIMENT

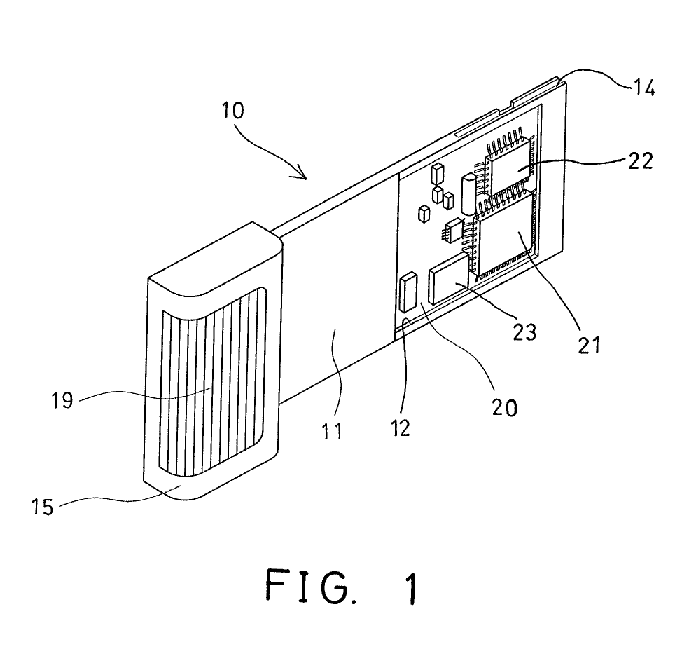

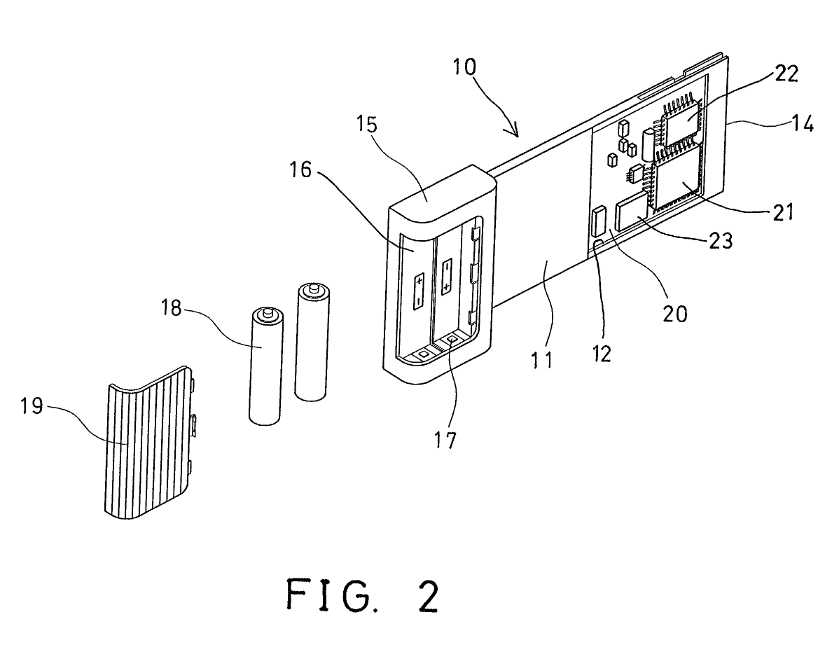

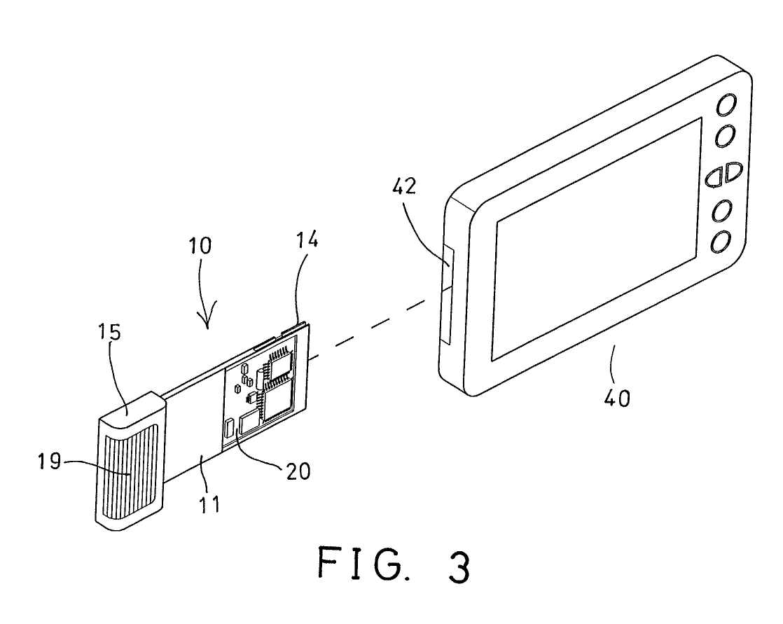

Referring to the drawings, and initially to FIGS. 1 and 2, a compact flash card 10 in accordance with the present invention comprises a card body 11 including a recess 12 formed therein for receiving and securing one or more circuit boards 20 therein, for example. The card body 11 includes a socket or a plug or a coupler 14 formed or provided on one end thereof for plugging or for coupling to the socket openings 42 of the personal digital assistant device 40 (FIG. 3), or coupling to the socket openings 43 of the notebooks 41, or for coupling to the other computer facilities or the other working stations, such as the personal computers, the pocket computers, or the digital cameras, etc.

The circuit board 20 may include one or more memories or integrated circuits or processor devices 21, 22 attached thereto, and may include a number of electric parts or elements 23 attached thereto, such as the resistors, the capacitors, the transistors, and the like, for memorizing or storing purposes for the computer facilities or the other working stations. The card body 11 includes a casing 15 attached thereto and having a chamber 16 formed therein for receiving one or more batteries 18 therein, and having one or more conductors 17 received therein for electrically coupling the batteries 18 to the circuit board 20, and for energizing the electric parts or elements and the memories or integrated circuits or processor devices 21, 22. A cover 19 may be detachably attached to the casing 15, for retaining the batteries 18 within the chamber 16 of the casing 15.

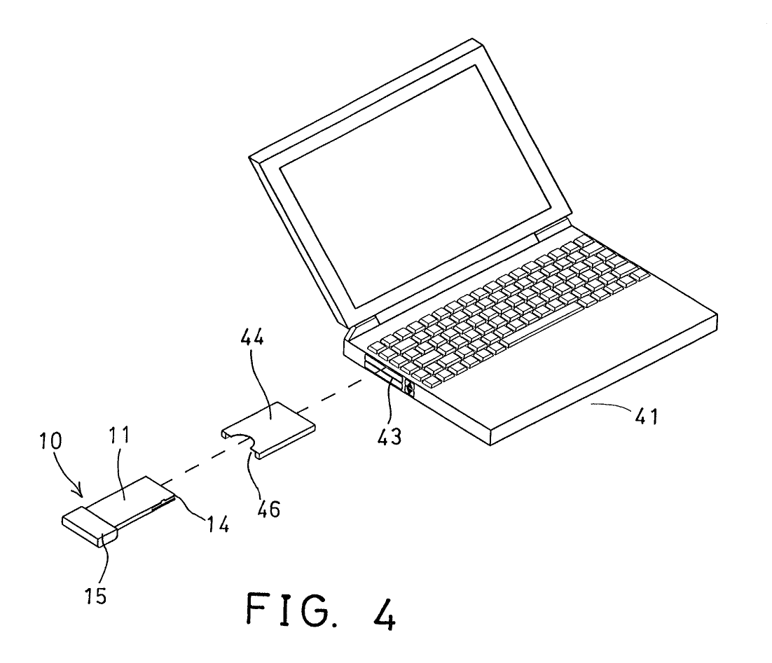

In operation, as shown in FIG. 3, the card body 11 of the compact flash card 10 may be directly plugged or coupled to the socket openings 42 of the personal digital assistant device 40 or of the other computer facilities or the other working stations. As shown in FIG. 4, the card body 11 of the compact flash card 10 may also be first plugged or coupled to the socket openings 46 of a transforming device 44, which may then be plugged or coupled to the notebook 41 or the other computer facilities or the other working stations. The transforming device 44 may be used for changing or transforming the compact flash card 10 to such as the personal computer memory card international association (PCMCIA) or the like.

Accordingly, the card body 11 of the compact flash card 10 includes one or more batteries 16 received in the casing 15 thereof for energizing the electric parts or elements and the memories or integrated circuits or processor devices 21, 22 of the circuit board 20, and for preventing the electric parts or elements of the circuit board 20 of the compact flash card 10 from consuming the electric energy of the computer facilities or the other working stations, such as the personal computers, the pocket computers, the digital cameras, the personal digital assistant device, or the notebooks.

Accordingly, the compact flash card in accordance with the present invention includes an energizing device for energizing the compact flash card itself, and for preventing the compact flash card from consuming the energy of the computer facilities or the other working stations.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A compact flash card for coupling to a computer facility, said compact flash card comprising:
a card body including a coupler provided therein for coupling to the computer facility,
a circuit board attached to said card body, and including a plurality of electric elements attached thereto, and
at least one battery attached to said card body and coupled to said circuit board for energizing said electric elements, and for preventing said compact flash card from consuming an electric energy of the computer facility.

2. The compact flash card according to claim 1, wherein said card body includes a casing attached thereto and having a chamber formed therein for receiving said at least one battery.

3. The compact flash card according to claim 2, wherein said card body includes at least one conductor disposed therein and electrically coupled between said at least one battery and said circuit board.

4. The compact flash card according to claim 2, wherein said card body includes a cover detachably attached to said casing for enclosing said chamber of said casing and for retaining said at least one battery in said chamber of said casing.

5. The compact flash card according to claim 1 further comprising a transforming device including a socket opening formed therein for receiving said coupler of said card body, and for coupling to the computer facility.
